(19) United States
(12) Patent Application Publication
(10) Pub. No.: US 2013/0335963 A1
(43) Pub. Date: Dec. 19, 2013

(54) LIGHTED REFLECTIVE SCULPTURE

(71) Applicant: Willis Electric Co., Ltd, (US)

(72) Inventor: Johnny Chen, Sindian City (TW)

(21) Appl. No.: 13/849,121

(22) Filed: Mar. 22, 2013

Related U.S. Application Data
(60) Provisional application No. 61/614,256, filed on Mar. 22, 2012.

(51) Int. Cl. F21V 33/00; F21V 7/00

(52) U.S. Cl. CPC F21V 33/0028; F21V 7/00
USPC 362/235

(57) ABSTRACT

A lighted decorative sculpture that includes a generally rigid support structure forming a decorative shape and having a generally planar first side opposite a generally planar second side; a reflective layer adjacent the front side of the support structure; and a plurality of light elements adjacent the first side of the support structure. Each of the plurality of light elements has a first lead and a second lead, the first lead projecting through the reflective layer and through the support structure, the second lead projecting through the reflective layer and through the support structure. A portion of light emitted from the light elements reflects off of the reflective layer and away from the decorative sculpture.

### RELATED APPLICATIONS

The present application claims the benefit of U.S. Provisional Application No. 61/614,256 filed Mar. 22, 2012, which is incorporated herein in its entirety by reference.

### TECHNICAL FIELD

The present invention relates generally to decorative lighted sculptures. More particularly, the present invention relates to lighted reflective sculptures for decorative display.

### BACKGROUND

Many types of lighted decorative sculptures are available to consumers. Such lighted decorative sculptures are often displayed during a holiday season, and may include indoor sculptures, outdoor sculptures, three-dimensional, sculptures, “two-dimensional” sculptures, and so on. Examples of three-dimensional, outdoor sculptures include life-size lighted deer having wire support frames, pumpkin lawn stakes, and so on. Examples of two-dimensional, indoor lighted sculptures include various types of lighted, two-sided window decorations with lights, intended to be hung by a user in a window, possibly using a suction cup and other such sculptures.

Such lighted sculptures typically include a frame with lights. The type of frame and form of lighting depends in part on how the sculpture is intended to be viewed. For example, an outdoor lighted deer or animal sculpture will typically include a three-dimensional, wire or metal frame with lights distributed about, and attached to, the frame. Such a sculpture is intended to be viewed from all angles. Other sculptures, such as a window decoration, may be intended to be viewed from only a front side, such that passers-by view the generally flat, two-dimensional image presented by the window sculpture. Such sculptures may include a correspondingly two-dimensional frame, with lights often attached to a front side only.

One of the most common lights used for these types of lighted sculptures, regardless of type, is a lamp having a miniature incandescent bulb supported by a housing or lamp holder. Such lights are often wired in series or series-parallel, with many lights, often up to 50, wired in series using traditional insulated conductors or wiring.

Traditional two-dimensional, or two-sided sculptures suffer aesthetically from the bulkiness of the many wires, lamp housings, connectors, and so on. This is especially true when traditional incandescent lamps with miniature bulbs are used, as described above. However, using LEDs instead of traditional incandescent lights offers many known advantages, such as energy savings, improved brightness, and longevity.

Some known sculptures have tried to utilize the advantages of LEDs by simply replacing the incandescent lamp with an LED lamp, while still relying on the traditional wiring and housing structures known in the industry. While such sculptures achieve the energy savings and longevity benefits of LEDs, the aesthetic qualities of the sculpture are not necessarily improved.

In an ornament patent to Lewis et al., U.S. Pat. No. 6,672,738, Lewis attempts to gain such benefits by using LEDs, and at the same time use printed circuit boards (PCBs) instead of traditional wiring. Surface-mount LEDs are back-mounted on a rear, non-viewing side of the PCB. The PCB is made up of a translucent material such that the LED light shines through the PCB from the rear side, and is visible at the front side, thus, presumably providing a glowing effect.

While an interesting lighting effect to some, such structures and techniques do not work well when a brighter or reflective effect, is desired.

### SUMMARY

In an embodiment, the present invention comprises a decorative, lighted reflective sculpture. The lighted reflective sculpture includes a generally rigid support structure comprising a nonconductive substrate material, the support structure forming a decorative shape and having a generally planar first side opposite a generally planar second side; a reflective layer adjacent the first side of the printed circuit board and covering a majority of a surface of the first side of the support structure; a first and a second conductive pathway formed on the second side of the support structure; a plurality of light elements adjacent the first side of the support structure, each of the plurality of light elements having a first lead and a second lead, the first lead projecting through the reflective layer and through the support structure and in electrical connection with the first conductive pathway, the second lead projecting through the reflective layer and through the support structure and in electrical connection with the second conductive pathway; and wherein the first and second conductive pathways provide power to the plurality of light elements causing at least of portion of light emitted from the light elements to reflect off of the reflective layer and away from the decorative sculpture.

Embodiments of the claimed invention provide superior reflective effects and advantages. Vertically positioned light elements, such as LEDs, with diffusive lenses allow light to emit outwardly and away from the sculpture, with some light being directed back to the uniform surface of the reflective layer. Without traditional opaque housings around the light elements and lenses, maximum light is allowed to be transmitted from the LED and reflected from the sculpture.

Further, the reflective effect of the lighted reflective sculpture may be particularly uniform and efficient, since all traces and electrical connections are located on a side opposite the light elements and the reflecting layer. Electrical leads of the light elements reside in holes through the frame and project to the rear side. This structure not only allows for a uniform, planar reflecting surface, but also allows light elements to be mounted adjacent to and in contact with, the reflective surface, thereby improving stability of the light elements.

Structurally, the sculpture may be particularly strong due to the use of a rigid frame, such as a printed circuit board (PCB), but also aesthetically pleasing since conductive traces and electrical connections are located on a rear side.

### BRIEF DESCRIPTION OF THE DRAWINGS

The invention may be more completely understood in consideration of the following detailed description of various embodiments of the invention in connection with the accompanying drawings, in which:

FIG. 1 is a front view of a reflective decorative sculpture according to an embodiment of the claimed invention;

FIG. 2 is a front view of a reflective layer of the reflective decorative sculpture of FIG. 1;

FIG. 3 is a right-side view of the reflective layer of FIG. 2;

FIG. 4 is a front view of a frame portion of the reflective decorative sculpture of FIG. 1;

FIG. 5 is a rear view of the frame portion of FIG. 4, depicting conductive pathways;

FIG. 6 is a right-side view of the frame portion of FIGS. 4 and 5;

FIG. 7 is a left side, cross-sectional view of an end portion of the reflective decorative sculpture of FIG. 1, depicting light emissions from light elements;

FIG. 8 is a top, cross-sectional view of the end portion of FIG. 7;

FIG. 9 is a front view of a rigid frame according to an alternate embodiment of a reflective decorative sculpture;

FIG. 10 is a rear view of the rigid frame of FIG. 9, depicting conductive pathways and surface-mount light-emitting diodes (LEDs);

FIG. 11 is a front view of a reflective layer corresponding to the rigid frame of FIGS. 9 and 10, depicting cutouts for the surface-mounted LEDs; and

FIG. 12 is a left side, cross-sectional view of an end portion of an alternate reflective decorative sculpture having front and rear reflective surfaces and light elements, depicting light emissions from front and rear light elements.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

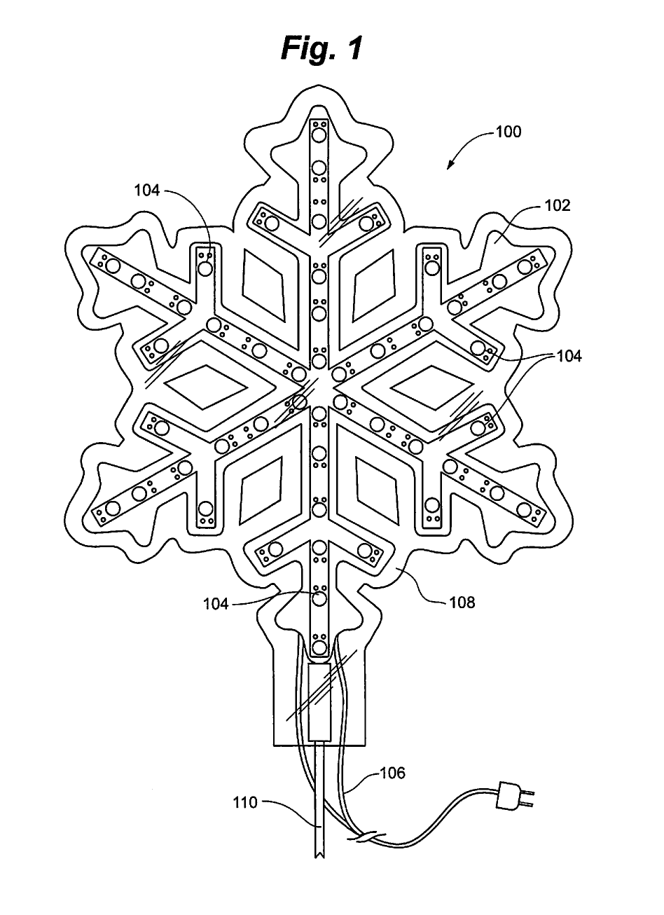

Referring to FIG. 1, an embodiment of a reflective decorative sculpture 100 is depicted. Sculpture 100, in an embodiment, includes reflective frame 102, multiple light elements 104, power cord 106, sculpture cover 108, and support base 110. In other embodiments, sculpture 100 may not include sculpture cover 108 and support base 110.

Light elements 104 are mounted adjacent reflective frame 102, and power cord 106 is in electrical communication with light elements 104. Sculpture cover 108 surrounds reflective frame 102 and light elements 104. Support base 110 is attached to reflective frame 102 at one or more points.

In the embodiment depicted, reflective decorative sculpture 100 comprises a snowflake shape. However, it will be understood that reflective decorative sculpture 100 is not limited to such a shape, and may comprise other decorative shapes, including, but not limited to those resembling a tree, tree ornament, snowman, human figure, animal figure, star, and other such shapes, figures and icons.

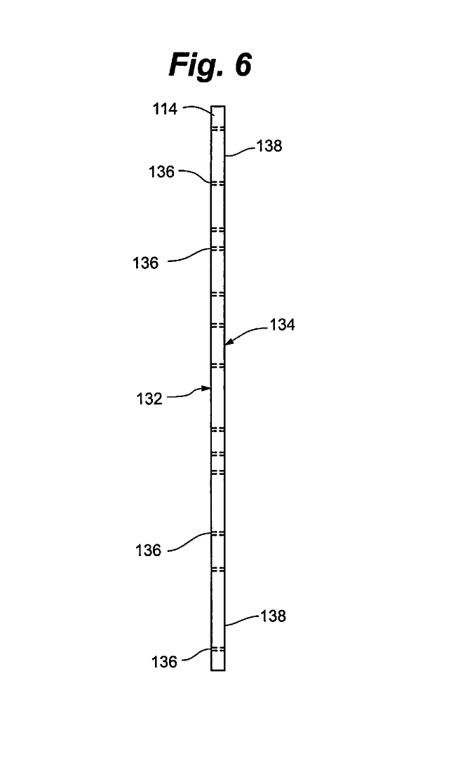

Referring also to FIGS. 2-6, reflective frame 102 includes front reflective layer 112 and frame portion 114. Front reflective layer 112 includes reflective front surface 116 and rear surface 118. Front reflective layer 112 also defines multiple pairs of light-element lead holes 120. Each pair of lead holes 120 includes a first lead hole 120a and a second lead hole 120b.

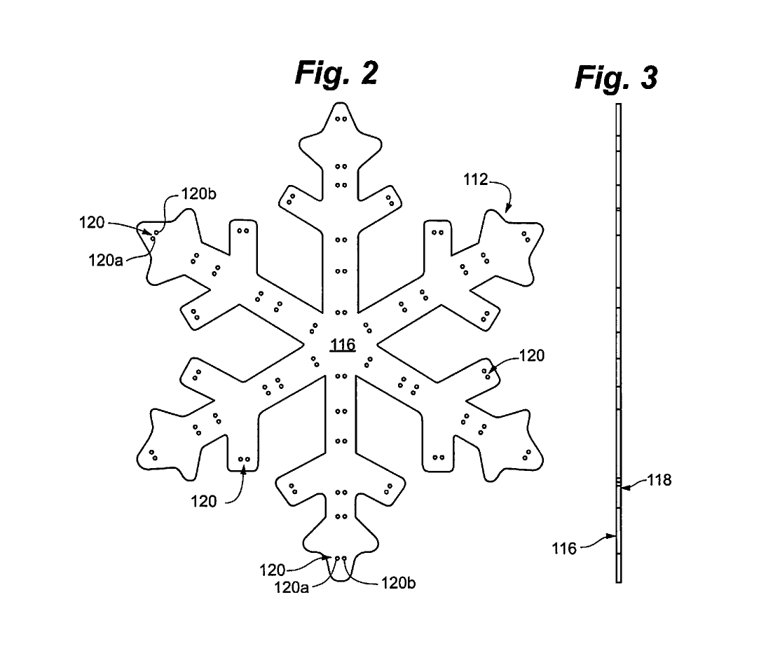

Referring specifically to FIGS. 2 and 3, in an embodiment, front reflective layer 112 comprises a generally flat, thin, reflective material that may be cut, or otherwise formed, into a shape complementary to a shape of frame portion 114. In such an embodiment, reflective layer 112 covers generally all of frame portion 114 when placed adjacent a front side of frame portion 114. In other embodiments, front reflective layer 112 may not be shaped to resemble the shape of underlying frame portion 114. In one such embodiment, front reflective layer 112 may be smaller than frame portion 114.

Front reflective layer 112 includes reflective front surface 116 that reflects substantially all light, or a portion thereof. Layer 112 may comprise a single material, such as a reflective plastic material or reflective metal material. In other embodiments, front reflective layer 112 may comprise multiple layers of materials, with an outer layer forming surface 116. In such an embodiment, the outer layer forming surface 116 may comprise a different material from an inner layer, and may include a reflective coating. Layer 112 may be generally thin and flexible such that if conforms to surfaces of frame portion 114 when placed adjacent frame portion 114.

In an embodiment, reflective layer 112 is generally not translucent, such that light is generally not transmissible from a rear surface 118 to a front surface 116. In other embodiments, reflective layer 112 may be translucent enough to allow some light to pass through from rear to front.

Front reflective layer 112 also includes rear surface 118. Rear surface 118 in an embodiment is placed adjacent to, and in contact with, frame portion 114 when reflective decorative sculpture 100 is assembled.

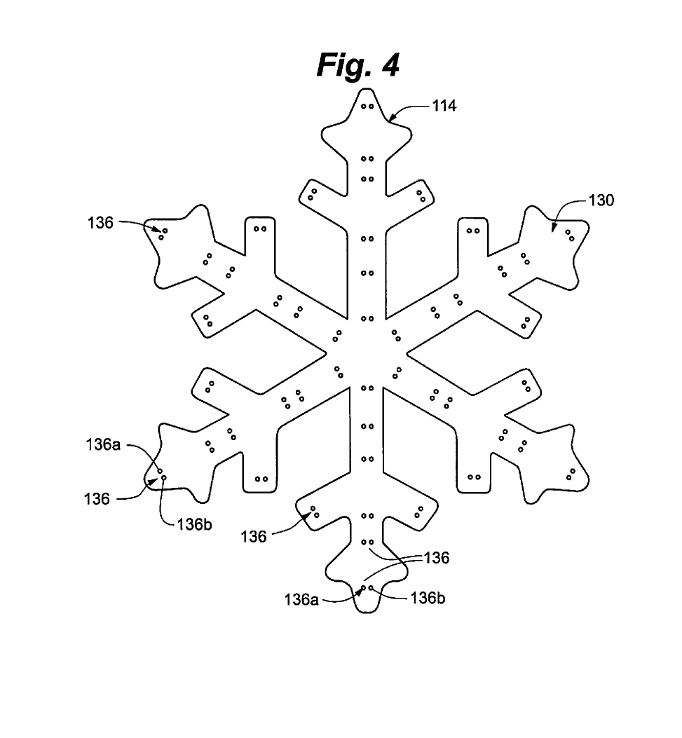

Referring specifically to FIGS. 4-6, frame portion 114 comprises a generally rigid, planar material. In an embodiment, and as depicted, frame portion 114 comprises a printed circuit board.

In an embodiment, frame portion 114 includes non-conductive substrate 130 having front surface 132 and rear surface 134, and defining multiple light element lead hole pairs 136. Substrate 130 may be non-translucent, or in some embodiments, translucent, though it is not an objective of the claimed invention to transmit light from a rear surface 134 through the substrate material to a front surface 132. Lead hole pairs 136 generally align with lead holes 120 of reflective layer 112 when frame portion 114 is adjacent to reflective layer 112. Each lead hole pair includes a first lead hole 136a and a second lead hole 136b.

Frame portion 114 also includes multiple conductive pathways 138 dispersed about rear surface 134, with most conductive pathways 138 extending from one lead hole 136 to another lead hole 136, providing electrical pathways between light elements 104. As will be understood by those skilled in the art of printed circuit boards, conductive pathways 138 may comprise thin conductive sheets, such as copper traces.

In an embodiment, all conductive pathways 138, and electrical connections, are located on rear surface 134, and none on front surface 132. As such, front surface 132 remains a generally flat, planar surface with multiple holes, but with no other significant elements, such as conductive pathways or other components. On the other hand, rear surface 134 includes conductive pathways 138, power terminals 140, and as described further below, will also include solder joints connecting leads of light elements 104 to conductive pathways 138. As such, rear surface 134 comprises a somewhat uneven surface as compared to the relatively even, uniform front surface 132.

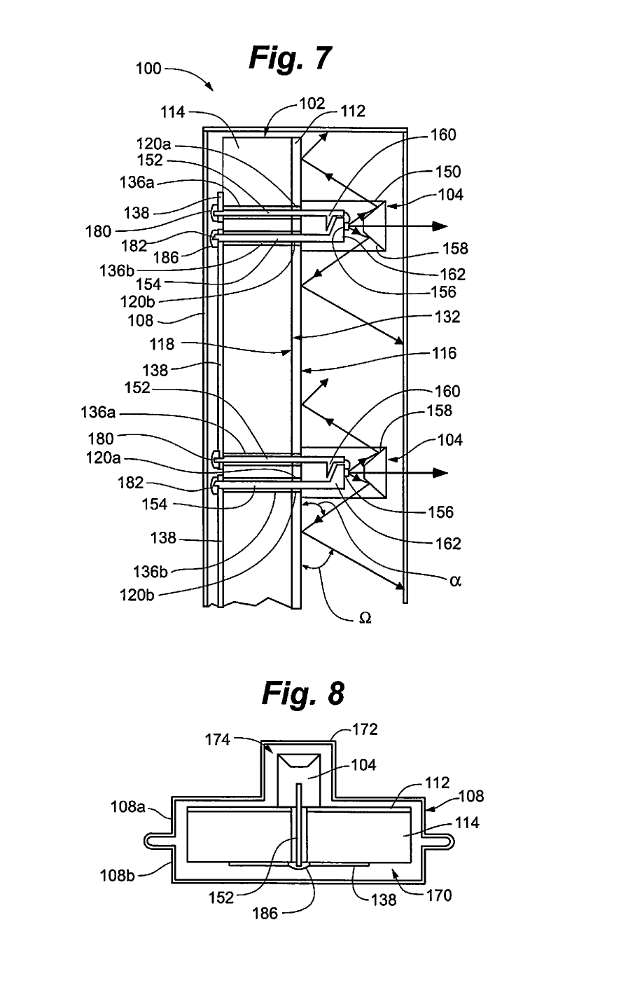

Referring FIG. 7, light elements 104 may comprise light-emitting diode (LED) assemblies, though in other embodiments, may comprise traditional incandescent bulbs. In an embodiment wherein light elements 104 comprise LED assemblies, each light element 104 includes lens 150, first lead 152 (anode), second lead 154 (cathode), and LED chip 156.

Leads 152 and 154 may be typical rigid leads, or may in other embodiments be more flexible, bendable leads.

Lens 150 may comprise any of known LED lens materials, such as an expoy resin, or other such translucent or transparent plastic material, with or without reflective coatings or surfaces. Lens 150 may comprise any of a variety of shapes, including a cylindrical shape with or without a domed top. In the embodiment depicted, lens 150 also includes internal reflecting surface 158 within lens 150, which in an embodiment may be conical or frustoconical (depicted).

Lens may be substantially clear, or may comprise any of a variety of colors. In some embodiments, the lens color may match the color of the light emitted by LED chip 156; in other embodiments, the lens color may not match the emitted light.

As depicted, lens 150 comprises the entire structure or housing surrounding and supporting proximal ends 160 and 162 of first and second leads 152 and 154 and LED chip 156. Such an embodiment allows a maximum amount of light to be transmitted away from LED chip 156, through lens 150, towards reflecting layer 112, thusly maximizing light seen by a viewer. In contrast, traditional LED bulb assemblies that include lamp holders or other housings, comprising opaque plastics supporting the LED lens, tend to block a portion of light emitted from the LED lens that would otherwise be transmitted toward reflecting surface 112. As discussed further below, using an LED lens 150 without a traditional housing, and positioning that LED lens directly adjacent a reflecting surface, maximizes reflected light and aesthetic appearance of the reflective decorative sculpture 100.

Referring also to FIG. 1, sculpture cover 108 generally surrounds reflective frame 102 and its attached light elements 104, and may comprise a transparent or translucent material. Such material may include a plastic material. In an embodiment, cover 104 covers substantially all of a front side and a rear side of reflective frame 102. In another embodiment, cover 104 covers primarily a front side of reflective frame 102. In other embodiments, cover 104 covers only a portion of either a front side or rear side of reflective frame 102.

Referring also to FIG. 8, in an embodiment, sculpture cover 104 comprises front portion 108a joined to rear portion 108b, which together define frame cavity 170. Front portion 108a may be conformal, such that it substantially conforms to the contour of reflective frame 102 and light elements 104, forming raised portion 172. Raised portion 172 defines light-element channel 174, which houses light elements 104.

Referring to FIGS. 1, 7, and 8, when assembled, rear side 118 of reflective layer 112 is in contact with, and adjacent to, front surface 132 of frame portion 114. Reflective layer 112 in an embodiment is sufficiently thin and flexible to conform to surface 132 of frame portion 114. In an embodiment, and as described above, surface 132 is generally free of aberrations, bumps, or raised portions that when present would cause reflective layer 112 to deform, which in turn would be manifested in corresponding aberrations, bumps or raised portions in front surface 116. In such a flat, planar embodiment, front surface 116 of reflective layer 112 remains flat and generally planar, providing a superior reflecting surface.

At least a portion of lead hole pairs 120 of reflective layer 112 align with, and are coaxial to, lead hole pairs 136 of frame portion 114.

Each pair of leads 152 and 154 of each light element 104 is inserted through a lead hole pair 120 and a lead hole pair 136, such that first distal end 180 of first lead 152 and second distal end 182 of second lead 154 of each ht element 104 extends through lead holes 120a, 136a, 120b, and 136b, respectively.

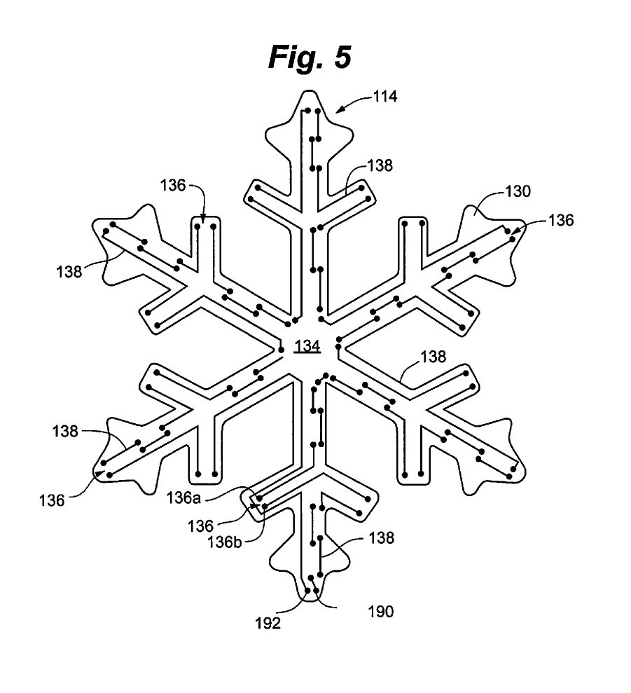

Distal end 180 of lead 152 and distal end 182 of lead 154 of each light element 104 are electrically connected to one or more conductive pathways 138. In an embodiment, leads 152 and 154 are connected to conductive pathways via a solder joint, or solder connection 186, thusly forming an electrical connection between leads 152 and 154 and their respective conductive pathways 138, which in turn are electrically connected to power terminals 190 and 192 (see FIG. 5). Solder connection 186 may cause a raised bump or projection that rises above conductive pathway 186.

In an embodiment, light elements 104 are electrically connected in series via conductive pathways 138, receiving power via power terminals 190 and 192 and power cord 106. In other embodiments, light elements 104 are electrically connected in parallel, or in series parallel.

As depicted, lens 152 at a bottom surface is adjacent to, and in contact with front surface 116 of reflective layer 112. Lens 152 may generally be oriented perpendicular to reflective layer 112, such that a vertical axis parallel to leads 152 and 154 is perpendicular to a plane formed by surface 116 of reflective layer 112. In other embodiments, lens 152 is generally transverse to surface 116 of reflective layer 112.

In the embodiment depicted and described above, situating lens 152 to be in contact with reflective layer 112 provides additional structural support for light element 104 such that leads 152 and 154 are unlikely to be bent if subjected to unusual forces due to mishandling or dropping of sculpture 100. In other embodiments, lenses 152 may not be in direct contact with reflective layer 112.

As described above, when sculpture cover 108 is used, cover 108 surrounds at least a portion of reflective frame 102 and light elements 104, with light elements 104 residing in light element channels 140. Sculpture cover 108 provides structural protection for sculpture 100, and shields conductive pathways from contact with users and foreign, possibly conductive, surfaces and objects. Further, as will be described further below, in some embodiments, sculpture cover 108 may contribute to the reflective properties of sculpture 100.

In operation, power, which may be alternating current (AC) or direct current (DC) is transmitted from an external power source (not depicted) via power cord 106 to power terminals 190 and 192 (see FIG. 5). Power is transmitted along conductive pathways 138 and solder connections 186 to light elements 104. Sculpture 100 may also include additional power conditioning components, such as rectifiers, not depicted in the figures.

In an embodiment wherein light elements 104 comprise LED chips 156, as depicted, LED chips 156 emit light when powered. LED chips 156 may comprise a single chip emitting a single-color light, or may comprise multiple LEDs, such as a red-green-blue (RGB) diode. Light elements 104 may also include, or may be connected to, additional electrical control components that may control the brightness of light element 104, or may otherwise cause light elements 104 to operate according to a desired function, such as flashing, blinking, fading, and so on. Such additional control components may be integral to light elements 104, or may be in electrical connection with light elements 104 via conductive pathways 138, the control components being mounted on or near frame portion 114.

Referring specifically to FIG. 7, light elements 104 are depicted emitting light. The arrows of FIG. 7 indicate a direction of travel of portions of light emitted from light elements 104.

Generally, light emission from LEDs tends to be somewhat unidirectional, or at least is not ideally distributed or diffused from the LED chip within the LED lens. Accordingly, lens 150 acts to diffuse or refract some of the light emitted from LED chip 156. While some light emitted from LED chip 156 is diffused perpendicularly away from reflective layer 112 through lens 150, some of the light is reflected from lens 150 back toward surface 116 of reflective layer 112, as depicted by the arrows in FIG. 7. Light may be incident at surface 116 at an incoming angle α.

Light reflected back to surface 116 is reflected away from surface 116 at an outgoing angle Ω. When surface 116 is substantially flat and planar, angle α is substantially equal to outgoing angle Ω. Therefore, when all light elements 104 are arranged in substantially the same orientation, and surface 116 is generally flat and planar, light is reflected substantially uniformly from surface 116 across the entire lighted reflective sculpture 100. Disruptions in surface 116 may cause light emitted from nearby light elements 104 to appear to be emitted in a different, non-uniform direction, such that a particular light element 104 or lighted region appears brighter or dimmer than other light elements or regions, depending on the viewing angle. As described previously, having conductive pathways 138 and electrical connections to light elements on the non-reflective side improves the flatness and uniformity of reflective surface 116, contributing to the improved reflective properties of sculpture 100.

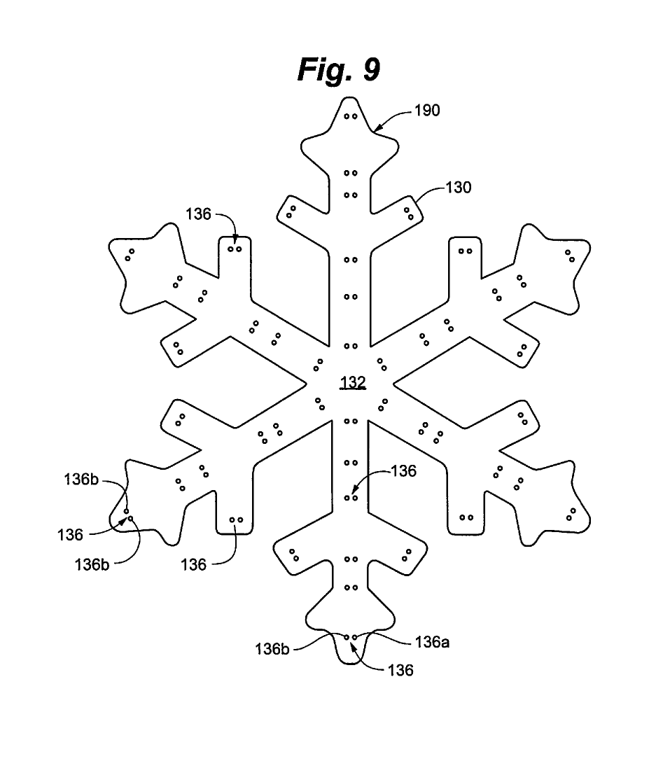

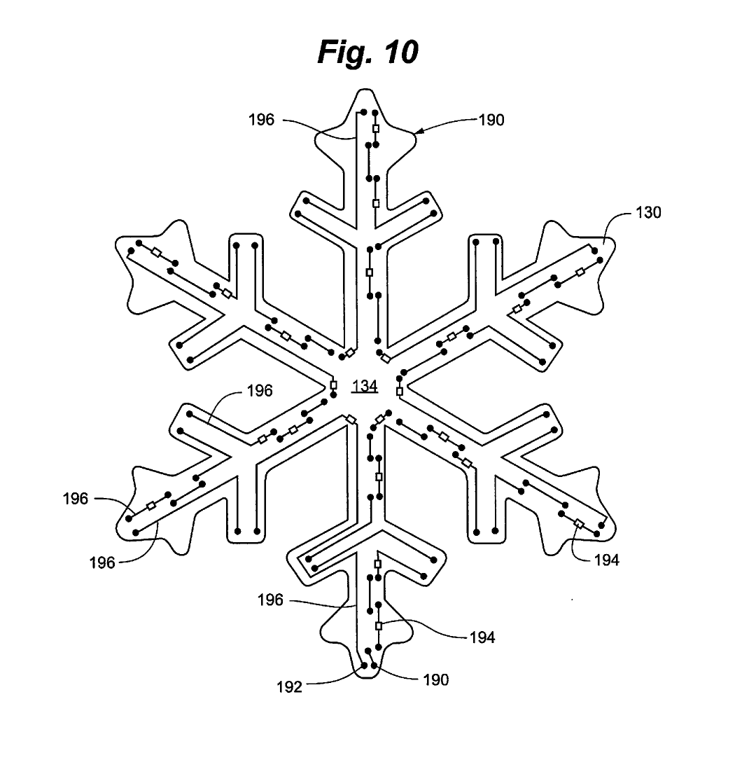

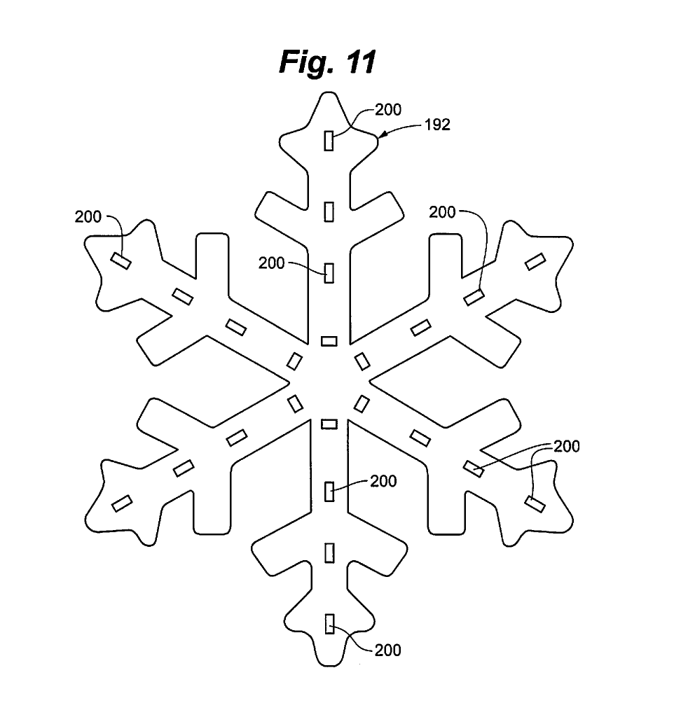

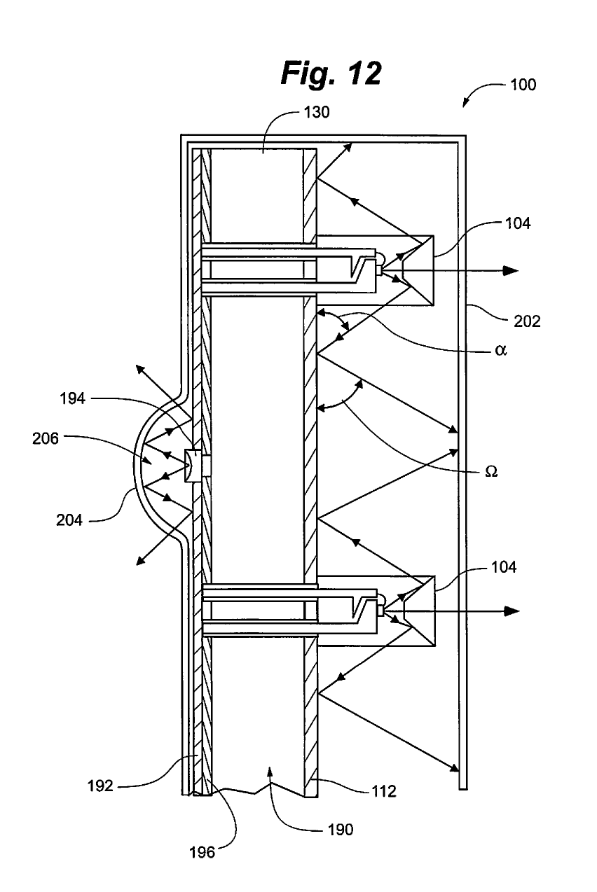

Referring to FIGS. 9-12, in an alternate embodiment, lighted reflective sculpture 100 may not only include a front reflective layer, but may also include a rear reflective layer with additional light elements. In this embodiment, sculpture 100 is substantially the same as described above, with at least the exceptions of an alternate frame portion 190 as depicted in FIGS. 9 and 10 replacing the previously described frame portion 114, and with an additional reflective layer 192 depicted in FIG. 11, and additional rear light elements 194 depicted in FIGS. 10 and 12.

Referring specifically to FIGS. 9 and 10, frame portion 190 is substantially the same as frame portion 114, comprising a rigid body 130, front surface 132, rear surface 134, conductive pathways 196 and defining lead hole pairs 136, each including holes 136a and 136b. However, frame portion 190 also includes rear light elements 194 attached to rear surface 134.

In the depicted embodiment, rear light elements 194 comprise surface-mount. LEDs mounted to surface 134 and electrically connected to conductive pathways 196. In other embodiments, rear light elements 194 could comprise other light elements, such as traditional LEDs with leads, or incandescent bulbs. In one such alternate light elements 194 would be attached to surface 134, and would not penetrate body 134 through holes.

Rear light elements 194 may be connected in series with front light elements 104 via conductive pathways 190, or may be connected in other electrical configurations, such as parallel, or series-parallel. In other embodiments, rear light elements 194 may comprise a separate electrical circuit independent of front light elements 104.

Similar to front light elements 104, rear light elements 194 may be distributed about surface 134 of frame portion 190, and may comprise any number of light elements depending on electrical feasibility, and desired appearance.

Referring specifically to FIGS. 11 and 12, in this alternate embodiment, sculpture 100 includes rear reflective layer 192. Rear reflective layer 192 is substantially the same as front reflective layer 112, having front reflective surface 116 and rear reflective surface 118. However, rather than including lead hole pairs 120, rear reflective layer 192 includes multiple rear light cutouts 200. Rear light cutouts receive rear light elements 194, such that rear light elements 194 project above surface 116 of rear reflective layer 192.

Referring specifically to FIG. 12, sculpture 100 in this alternate embodiment includes an alternate sculpture cover 202. Cover 202 may be substantially the same as cover 108, with the exception that cover 202 may include raised portions 204 that define rear light cavities 204. Rear light cavities 204 may be generally positioned above rear light elements 194, and may receive a portion of rear light elements 194. In other embodiments, cover 202 may not include raised portions 204.

In an embodiment, rear light elements 194 are generally not as bright as front light elements 104. The effect is that a front side, or primary viewing side, of sculpture 100 presents a relatively bright, reflective sculpture face, while the rear side of sculpture 100 presents a secondary, contrasting viewing side that is more dimly lit.

When lit, and when cover 202 includes raised portions 204, rear light elements 194 emit light toward raised portions 204, which in an embodiment may be bubble-shaped. In an embodiment, cover 202 refracts the light, such that a portion of the incident light reflects back toward reflective surface 116 of reflective layer 192, and light emitted from rear light elements 194 is dispersed more widely than would otherwise be the case without a cover. This is especially helpful as surface-mount LEDs may be particularly unidirectional.

In contrast, the embodiment of sculpture 100 is only lit on a front side. Generally, for “two-dimensional” sculptures or displays, one side is a primary viewing side, and is faced towards potential viewers with little need for a lit rear side. An example is where sculpture 100 comprises a sculpture staked into the ground in front of a house via support base 110, with a front side facing viewers passing by or approaching the house. In such an example, if a rear side is lit, a person looking out of the house, or leaving the house will view an interesting perspective of a brightly lit front side shining away from them, and a dimly lit rear side. Further, the lit rear side allows a viewer approaching from the rear to be able to more precisely locate the position of the sculpture so as to avoid tripping over, or otherwise accidentally contacting, the sculpture.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A lighted decorative sculpture, comprising:
a generally rigid support structure comprising a non-conductive substrate material, the support structure forming a decorative shape and having a generally planar first side opposite a generally planar second side;
a reflective layer adjacent the front side of the support structure;
a first and a second conductive pathway formed on the second side of the support structure;
a plurality of light elements adjacent the first side of the support structure, each of the plurality of light elements having a first lead and a second lead, the first lead projecting through the reflective layer and through the support structure and in electrical connection with the first conductive pathway, the second lead projecting through the reflective layer and through the support structure and in electrical connection with the second conductive pathway; and
wherein the first and second conductive pathways provide power to the plurality of light elements causing at least of portion of light emitted from the light elements to reflect off of the reflective layer and away from the decorative sculpture.

2. The decorative sculpture of claim 1, wherein the reflective layer presents a substantially uniform reflective face.

3. The decorative sculpture of claim 1, further comprising a plurality rear light elements adjacent the back side of the support structure, each of the plurality of rear light elements emitting less light than each of the plurality of light elements adjacent the front side of the support structure.

4. The decorative sculpture of claim 1, further comprising a transparent protective cover surrounding the sculpture.

5. The decorative sculpture of claim 1, wherein the light elements include light-emitting diodes (LEDs).

6. The decorative sculpture of claim 1, wherein the reflective layer covers a majority of a surface of the first side of the support structure.

7. A lighted decorative sculpture, comprising:
a generally rigid support structure comprising a non-conductive substrate material, the support structure forming a decorative shape and having a generally planar first side opposite a generally planar second side;
a reflective layer adjacent the first side of the support structure;
a first plurality of light elements adjacent the first side of the support structure such that light emitted from the plurality of light elements reflects off of the reflective layer and outwardly away from the first side of the decorative sculpture; and
a second plurality of light elements adjacent the second side, the light elements configured to emit light outwardly and away from the second side of the decorative sculpture.

8. The lighted decorative sculpture of claim 7, wherein the first plurality of lights are brighter than the second plurality of lights.

9. The lighted decorative sculpture of claim 7, wherein the second plurality of lights comprises surface-mount light-emitting diodes.

10. The lighted decorative sculpture of claim 7, wherein the generally rigid support structure comprises a printed-circuit board.

11. The decorative sculpture of claim 7, further comprising a transparent protective cover surrounding the sculpture.

12. The decorative sculpture of claim 7, further comprising a first and a second conductive pathway formed on the second side of the support structure;
wherein each of the plurality of first light elements has a first lead and a second lead, the first lead projecting through the reflective layer and through the support structure and in electrical connection with the first conductive pathway, the second lead projecting through the reflective layer and through the support structure and in electrical connection with the second conductive pathway; and
wherein the first and second conductive pathways provide power to the plurality of first light elements.

13. The decorative sculpture of claim 7, wherein the second side does not comprise a reflective layer.

14. A covered lighted decorative sculpture, comprising:
a support structure forming a decorative shape and having a first side and a second side;
a reflective layer adjacent the first side of the printed circuit board;
a first plurality of light-emitting diodes (LEDs) adjacent the reflective layer; and
a refractive cover covering substantially all of the first plurality of LEDs, the refractive cover causing a first portion of light emitted from the LEDs to be reflected back toward the reflective layer and allowing a second portion of the light emitted from the LEDs to be transmitted through the refractive cover.

15. The covered lighted decorative sculpture of claim 14, wherein the first plurality of LEDs includes a first lead and a second lead, the first lead projecting through the reflective layer and through the support structure and in electrical connection with a first conductive pathway, the second lead projecting through the reflective layer and through the support structure and in electrical connection with a second conductive pathway, the first and the second conductive pathways providing power to the LEDs.

16. The covered lighted decorative sculpture of claim 14, wherein the reflective layer covers a majority of a surface of the first side of the support structure

17. The covered, lighted decorative sculpture of claim 14, wherein the refractive cover comprises a transparent material.

18. The covered, lighted decorative sculpture of claim 14, further comprising a second plurality of LEDs adjacent the second side;
wherein the refractive cover surrounds both the first side and the second side of the support structure, and surrounds both the first plurality and second plurality of LEDs.

19. The covered, lighted decorative sculpture of claim 14, wherein the first side and the second side of the support structure each comprise a generally planar surface.

20. The covered, lighted decorative sculpture of claim 14, wherein the refractive cover comprises a raised channel for receiving a portion of the first plurality of LEDs.
